(19) United States
(12) Patent Application Publication
(10) Pub. No.: US 2025/0314553 A1
(43) Pub. Date: Oct. 9, 2025

(54) NOVEL DEMODULATION METHOD WITH A REFERENCE SIGNAL FOR OPERATIONAL MODAL ANALYSIS AND BASELINE-FREE DAMAGE DETECTION OF A STRUCTURE UNDER RANDOM EXCITATION

(71) Applicant: UNIVERSITY OF MARYLAND, BALTIMORE COUNTY, Baltimore, MD (US)

(72) Inventors: Weidong ZHU, Ellicott City, MD (US); Linfeng Lyu, Halethorpe, MD (US); Ke Yuan, Halethorpe, MD (US)

(21) Appl. No.: 19/095,964

(22) Filed: Mar. 31, 2025

Related U.S. Application Data
(60) Provisional application No. 63/573,700, filed on Apr. 3, 2024.

(51) Int. Cl. G01M 5/00

(52) U.S. Cl. CPC G01M 5/0033; G01M 5/0066; G01M 5/0091

(57) ABSTRACT

A demodulation method with a reference signal is developed for operational modal analysis and damage detection of a sample structure under random excitation. The novel demodulation method can process measurements of the structure by a continuously scanning laser Doppler vibrometer (CSLDV) system and measurements of a reference point on the sample structure by a single-point laser Doppler vibrometer to estimate its modal parameters, such as damped natural frequencies and undamped mode shapes. Advantageously, the demodulation method with a reference signal can be used for baseline-free damage detection of the sample structure.

### CROSS REFERENCE TO RELATED APPLICATIONS

This application claims priority to U.S. Provisional Patent Application No. 63/573,700 filed on Apr. 3, 2024 in the name of Weidong Z H U, et al., entitled “A novel demodulation method with a reference signal for operational modal analysis and baseline-free damage detection of a beam under random excitation,” which is hereby incorporated by reference herein in its entirety.

### STATEMENT OF FEDERALLY SPONSORED RESEARCH

This invention was made with government support under Grant Number CMMI-1763024 awarded by the National Science Foundation. The government has certain rights in the invention.

### FIELD

The present invention relates to demodulation methods to process measurements of a sample structure, e.g., a beam or plate structure, by a continuously scanning laser vibrometer system and measurements of at least one reference point on the sample structure by a single-point laser vibrometer to estimate its modal parameters, such as damped natural frequencies and undamped mode shapes. Estimated undamped mode shapes of the sample structure are used for baseline-free damage detection.

### BACKGROUND

Dynamic behavior of a structure can be affected by a damage in it, and one can detect the occurrence of a damage by studying the dynamic behavior of the structure. Modal parameters, such as damped natural frequencies and undamped mode shapes, of the structure are used to describe its dynamic behavior, which are useful for damage detection. Modal parameters of a structure can be estimated by modal analysis, which includes experimental modal analysis (EMA) and operational modal analysis (OMA). EMA requires excitation measurement while OMA does not; thus OMA is more appropriate for a structure under an operational condition or under random excitation. Different damage detection methods were developed based on modal analysis. Valdes and Soutis studied the effect of delamination in a composite beam on its natural frequencies [Valdes, et al., 1999]. Lestari et al. used piezoelectric sensors to estimate curvature mode shapes of intact and damaged beams, and detected different types of damage in beams by comparing estimated curvature mode shapes of intact and damaged beams [Lestari, et al., 2007]. He et al. used curvature mode differences between intact and damaged beams to identify the number and degrees of damages [He, et al., 2017]. However, baseline information from undamaged test samples were needed in the above methods, and contact-type sensors were used in their tests, which can introduce mass loadings to test structures and affect their estimated modal parameters.

A laser Doppler vibrometer, which can accurately measure the surface velocity of a point on a structure, provides an efficient and non-contact way for OMA of the structure [Rothberg, et al., 2017]. However, it is difficult to use the laser Doppler vibrometer to measure vibrations of multiple points on the structure, and a scanning laser Doppler vibrometer (SLDV) system was developed to provide measurements with a high spatial resolution [Id.; Stoffregen, et al., 1985; Castellini, et al., 2006]. A scanner with a set of orthogonal mirrors was integrated into the SLDV system, and rotation angles of the mirrors could be controlled so that the laser spot of the SLDV system was moved to a desired position on the structure. The SLDV system measures the vibration of a point for a period of time and then moves its laser spot to the next point [Yuan, et al., J. Vib. Acoust., 2021; Vuye, et al., 2011]. To increase the efficiency for measuring a large number of points on the structure, a continuously scanning laser Doppler vibrometer (CSLDV) system was developed [Sriram, et al., 1990; Sriram, et al., 1992; Allen, et al., 2010; Chen et al., 2016]. Mirrors of a scanner in the CSLDV system continuously rotate so that the laser spot of the CSLDV system is swept along a prescribed trajectory on a structure. Recently, novel CSLDV systems including a tracking CSLDV [Lyu, et al., Mech. Syst. Signal Process., 2021; Lyu, et al., J. Sound Vib., 2022] and a three-dimensional (3D) CSLDV [Chen, et al., 2021; Yuan, et al., Mech. Syst. Signal Process., 2021; Yuan, et al., Exp. Mech., 2022; Yuan, et al., J. Sound Vib., 2022; Yuan, et al., 2023] were developed to accurately estimate transverse mode shapes of a rotating fan blade and 3D mode shapes, which include in-plane mode shapes, of stationary structures with flat and curved surfaces, respectively, which significantly extended application areas of CSLDV systems.

Different OMA methods have been developed to process responses from CSLDV measurements of structures to estimate their modal parameters, including natural frequencies, damping ratios, and mode shapes, and operational deflection shapes (ODSs) [Stanbridge, et al., 1999; Di Maio, et al., 2011; Xu, et al., 2017; Xu, et al., 2020; Yang, et al., 2014; Xu, et al., 2019]. A demodulation method and a polynomial method were developed to estimate ODSs of a structure subject to sinusoidal excitation [Stanbridge, et al., 1999; Di Maio, et al., 2011]. Estimated ODSs and their curvatures (CODSs) of a beam under sinusoidal excitation can be used for identifying a damage in it via a novel damage detection method with a curvature damage index (CDI) [Chen, et al., 2017]. The method is baseline-free since a polynomial with a proper order to fit ODSs of the structure from the demodulation method is used to simulate an associated undamaged structure. By designing a two-dimensional (2D) scan scheme on a plate with a thickness reduction damage, its full-field ODSs under sinusoidal excitation were estimated via CSLDV measurements, and the location of the damage was determined via the baseline-free damage detection method that was extended from one dimension to two dimensions [Chen, et al., J. Sound Vib., 2018]. The method was also used to accurately locate delaminations in composite plates [Chen, et al., J. Nondestruct. Eval., 2018; Chen, et al., 2019]. A damage detection method using modal rotational ODSs of a plate obtained from its CSLDV measurements was developed to locate cracks near its edge [Huang, et al., 2019]. However, the above methods are not suitable for structures under random excitation, which is the most practical excitation in real-world applications, since the demodulation method can only be used to process responses from CSLDV measurements of structures under sinusoidal excitation.

A lifting method was previously developed to estimate undamped modes shapes of a structure under random excitation [Xu, et al., 2019]. Estimated undamped mode shapes from the lifting method can be used for baseline-free damage detection. However, the Nyquist frequency of the CSLDV system when using the lifting method depends on the scan frequency, which is the number of times the CSLDV system completes a back-and-forth scan in one second. It is difficult to use the lifting method for OMA of a structure with high natural frequencies. Recently, a new OMA method for CSLDV measurements was developed to improve the traditional demodulation method to estimate undamped mode shapes of structures under random excitation, where a high scan frequency of the CSLDV system was not needed [Yuan, et al., Mech. Syst. Signal Process., 2021; Lyu, et al., J. Vib. Acoust., 2021; Lyu, et al., Mech. Syst. Signal Process., 2022]. However, estimated undamped mode shapes of structures using the improved demodulation method are not suitable for their baseline-free damage detection since bandpass filters are used to pre-process and smooth their measured responses.

It is desirable to have a new OMA method based on demodulation with a reference signal for estimating undamped mode shapes of a structure under random excitation. The demodulation method can process correlation functions between measurements of the CSLDV system and measurements of a reference sensor. Moreover, estimated 1D undamped mode shapes can be processed by the baseline-free damage detection method to identify locations of damages in the structure.

### SUMMARY

In some aspects, a demodulation method of estimating damped natural frequencies of a sample structure under random excitation is disclosed, said method comprising:
measuring the sample structure using a laser-based vibration measurement system;
measuring at least one reference point on the sample structure using a reference sensor system;
calculating a cross-correlation function between the measurements of the laser-based vibration measurement system and the measurements of the reference sensor system; and
transforming the cross-correlation function to a frequency spectrum to obtain the estimated damped natural frequency of the sample structure.

In some other aspects, a method of detecting damage to a sample structure is disclosed, said method comprising:
measuring the sample structure using a laser-based vibration measurement system;
measuring at least one reference point on the sample structure using a reference sensor system;
calculating a cross-correlation function between the measurements of the laser-based vibration measurement system and the measurements of the reference sensor system;
transforming the cross-correlation function to a frequency spectrum to obtain an estimated damped natural frequency of the sample structure under random excitation;
creating two sinusoidal signals from the estimated damped natural frequency of the sample structure;
obtaining an estimated undamped mode shape of the sample structure by multiplying the calculated cross correlation function by the two sinusoidal signals and filtering the result using a low-pass filter;
simulating a hypothetical undamaged structure using a fitted smooth polynomial to the estimated undamped mode shape of the sample structure; and
comparing the estimated undamped mode shape of the sample structure and the smooth polynomial of the undamaged structure using curvature damage indices (CDI) to determine the location of damage in the sample structure.

Other aspects, features and embodiments of the invention will be more fully apparent from the ensuing disclosure and appended claims.

### BRIEF DESCRIPTION OF THE FIGURES

FIG. 1A illustrates a schematic of a beam structure.

FIG. 1B illustrates the intact section of the beam structure.

FIG. 2 shows the preprocess of simulated responses from the finite element model.

FIG. 3A shows the simulated CSLDV measurements when the distance between the random force excitation and the fix end of the beam structure is x_{q}=0.37 m.

FIG. 3B shows the simulated CSLDV measurements when the distance between the random force excitation and the fix end of the beam structure is x_{q}=0.7 m.

FIG. 3C shows the simulated CSLDV measurements when the distance between the random force excitation and the fix end of the beam structure is x_{q}=1 m.

FIG. 4A shows the correlation function between simulated CSLDV measurements with x_{q}=0.37 m and the response of the node with η=0.5.

FIG. 4B shows the frequency spectrum associated with the simulation of FIG. 4A.

FIG. 4C shows the correlation function between simulated CSLDV measurements with x_{q}=0.7 m and the response of the node with η=0.7.

FIG. 4D shows the frequency spectrum associated with the simulation of FIG. 4C.

FIG. 4E shows the correlation function between simulated CSLDV measurements with x_{q}=1 m and the response of the node with η=0.9.

FIG. 4F shows the frequency spectrum associated with the simulation of FIG. 4E.

FIG. 5A shows the estimated first undamped mode shapes of the beam structure using the demodulation method and finite element model (FEM).

FIG. 5B shows the estimated second undamped mode shapes of the beam structure using the demodulation method and FEM.

FIG. 5C shows the estimated third undamped mode shapes of the beam structure using the demodulation method and FEM.

FIG. 6A shows the estimated averaged and normalized CDIs from first undamped mode shapes of the beam structure.

FIG. 6B shows the estimated averaged and normalized CDIs from second undamped mode shapes of the beam structure.

FIG. 6C shows the estimated averaged and normalized CDIs from third undamped mode shapes of the beam structure.

FIG. 7A illustrates a schematic of experimental investigation on OMA and damage detection methods disclosed herein.

FIG. 7B shows a schematic of the experimental setup of the beam structure with a thickness reduction damage.

FIG. 7C shows the algorithmic diagram of the demodulation method with a reference signal for OMA and damage detection.

FIG. 8A shows the vibration of the damaged beam structure under random excitation from CSLDV measurements.

FIG. 8B shows the frequency spectrum associated with the measurements of FIG. 4A.

FIG. 8C shows the correlation function between the response in FIG. 8A and the reference response at η=0.3.

FIG. 8D shows the frequency spectrum associated with FIG. 8C.

FIG. 8E shows the correlation function between the response in FIG. 8A and the reference response at η=0.8.

FIG. 8F shows the frequency spectrum associated with FIG. 8E.

FIG. 9A illustrates the comparisons between estimated mode shapes of the damaged beam structure from SLDV measurements and those from CSLDV measurements with references at η=0.3 and η=0.8 for its first mode.

FIG. 9B illustrates the comparisons between estimated mode shapes of the damaged beam structure from SLDV measurements and those from CSLDV measurements with references at η=0.3 and η=0.8 for its second mode.

FIG. 9C illustrates the comparisons between estimated mode shapes of the damaged beam structure from SLDV measurements and those from CSLDV measurements with references at η=0.3 and η=0.8 for its third mode.

FIG. 10A illustrates the estimated averaged and normalized CDIs from CSLDV measurements with references at η=0.3 and η=0.8 for the first mode of the damaged beam structure.

FIG. 10B illustrates the estimated averaged and normalized CDIs from CSLDV measurements with references at η=0.3 and η=0.8 for the second mode of the damaged beam structure.

FIG. 10C illustrates the estimated averaged and normalized CDIs from CSLDV measurements with references at η=0.3 and η=0.8 for the third mode of the damaged beam structure.

FIG. 11 illustrates the frequency spectrum of the correlation function between the response from the scanning head and the reference response at η=0.5.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s).” “having.” “has,” “can.” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising.” “consisting of” and “consisting essentially of,” the embodiments or elements presented herein, whether explicitly set forth or not.

As used herein, a curvature damage index (CDI) is a computational metric comparing the curvature of estimated mode shapes to polynomial-fitted equivalents, enabling damage localization without prior undamaged reference data. For example, in some embodiments, an estimated undamped mode shape is compared to a smooth polynomial fit to the estimated undamped mode shape.

As used herein, a “baseline-free” damage detection corresponds to conditions where baseline information from undamaged structures, e.g., beams, are not available or not obtained.

As used herein, “random excitation” uses a broad spectrum of frequencies simultaneously, and hence is different from “sinusoidal excitation,” which applies a single, controlled frequency.

As used herein, a “low-pass filter” allows frequencies below a certain cutoff to pass while attenuating higher frequencies, and hence is different from a “bandpass filter,” which allows a specific band of frequencies to pass, rejecting those both above and below that band.

As used herein, a “structure” includes, but is not limited to, a beam or a plate. As defined herein, a “beam” can be any structure that has a length that is substantially greater than the cross-sectional dimensions of the beam structure, for example, wherein the length is at least two times, at least three times, at least five times, at least ten times, at least fifteen times, at least twenty times, at least 25 times, at least 30 times, at least 40 times, at leave 50 times, at least 60 times, at least 70 times, at least 80 times, at least 90 times, at least 100 times, or more, greater than the cross-sectional dimensions of the beam structure. As defined herein, a plate can be any structure wherein the thickness, or depth, z is substantially less than the length x and/or the width y of the plate, for example, wherein the thickness, or depth, z is at least two times, at least three times, at least five times, at least ten times, at least fifteen times, at least twenty times, at least 25 times, at least 30 times, at least 40 times, at leave 50 times, at least 60 times, at least 70 times, at least 80 times, at least 90 times, at least 100 times, or more, less than the length x and/or the width y of the plate. It should be appreciated by the person skilled in the art that the structure can be made of any material known in the art including, but not limited to, metals, alloys, polymers, wood, concrete and other aggregates. In some embodiments, the structure materials are reinforced.

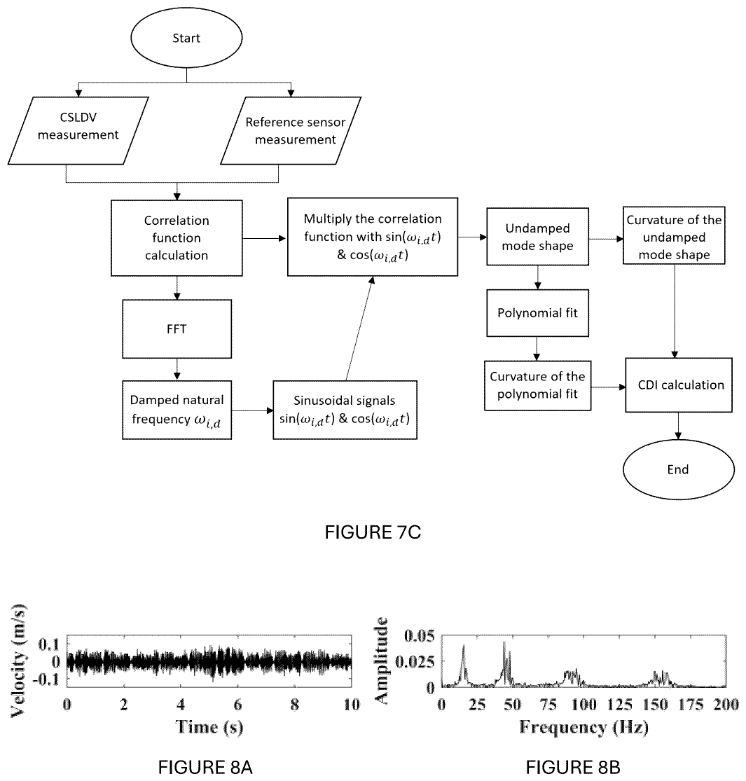

Broadly, with reference to FIG. 7C herein, a demodulation method with a reference signal is disclosed for operational modal analysis and damage detection of a sample structure under random excitation. The demodulation method can process laser-based vibration measurements and measurements of at least one reference point on the sample structure to estimate the sample structure's modal parameters, such as damped natural frequencies and undamped mode shapes. A cross-correlation function between laser-based vibration measurements and the reference point measurements is calculated, and damped natural frequencies of the sample structure are estimated by applying a fast Fourier transforms (FFT) processing method to transform the cross-correlation function to a frequency spectrum to obtain an estimated damped natural frequency of the sample structure. Using the estimated damped natural frequency, an estimated undamped mode shape of the sample structure can be obtained. Smooth polynomials are used to fit estimated undamped mode shapes, which can be considered as undamped mode shapes of an undamaged structure. Curvatures of estimated undamped mode shapes and polynomials are compared by curvature damage indices to determine the location of a damage in the sample structure. Advantageously, the demodulation method with a reference signal can be used to obtain baseline-free damage detection of the sample structure.

In a first aspect, a demodulation method of estimating damped natural frequencies of a sample structure under random excitation is described, said method comprising:
measuring the sample structure using a laser-based vibration measurement system;
measuring at least one reference point on the sample structure using a reference sensor system;
calculating a cross-correlation function between the measurements of the laser-based vibration measurement system and the measurements of the reference sensor system; and
transforming the cross-correlation function to a frequency spectrum to obtain the estimated damped natural frequency of the sample structure.

In some embodiments, the laser-based vibration measurement system is a continuously scanning laser vibrometer (CSLV) system. In some embodiments, the CSLV system is a continuously scanning laser Doppler vibrometer (CSLDV) system. In some embodiments, the laser-based vibration measurement system includes a scanner. In some embodiments, the laser-based vibration measurement system includes a scanner with a set of orthogonal mirrors. In some embodiments, the laser-based vibration measurement system scans at least a portion of a surface of the sample structure using a one-dimensional (1D) scan scheme. In some embodiments, the laser-based vibration measurement system scans at least a portion of a surface of the sample structure using a two-dimensional (2D) scan scheme.

In some embodiments, the reference sensor system comprises a single-point laser vibrometer, e.g., a single-point laser Doppler vibrometer.

In some embodiments, the cross-correlation function is transformed to a frequency spectrum using a signal processing method such as FFT, and an estimated damped natural frequency of the sample structure is obtained. From the estimated damped natural frequency of the sample structure, two sinusoidal signals can be created, for example, sin (ω_{i,d}t) and cos (ω_{i,d}t). Thereafter, an estimated undamped mode shape can be obtained by multiplying the two sinusoidal signals by the cross-correlation function and filtering the result using a low-pass filter.

In some embodiments, the estimated undamped mode shape of the sample structure is used to detect damage to the sample structure. First, a hypothetical undamaged structure is simulated using a fitted smooth polynomial to the estimated undamped mode shape of the sample structure, which permits the baseline-free damage detection described herein. Second, the estimated undamped mode shape of the sample structure and the smooth polynomial representing the hypothetical undamaged structure are compared using CDI to determine the location of damage in the sample structure. In some embodiments, locating the damage in the sample structure is evidence that the sample structure is damaged. In some embodiments, two or more CDIs are averaged and normalized to mitigate noise effects to further improve damage location identification. In some embodiments, CDIs in normalized ranges [0, 0.1] and [0.9, 1] of the full length of the sample structure were disregarded to eliminate effects of spurious boundary anomalies.

In some embodiments, the sample structure is a beam structure. In some other embodiments, the sample structure is a plate structure.

In a second aspect, a method of detecting damage to a sample structure is described, said method comprising:
measuring the sample structure using a laser-based vibration measurement system;
measuring at least one reference point on the sample structure using a reference sensor system;
calculating a cross-correlation function between the measurements of the laser-based vibration measurement system and the measurements of the reference sensor system;
transforming the cross-correlation function to a frequency spectrum to obtain an estimated damped natural frequency of the sample structure under random excitation;
creating two sinusoidal signals from the estimated damped natural frequency of the sample structure;
obtaining an estimated undamped mode shape of the sample structure by multiplying the calculated cross correlation function by the two sinusoidal signals and filtering the result using a low-pass filter;
simulating a hypothetical undamaged structure using a fitted smooth polynomial to the estimated undamped mode shape of the sample structure; and
comparing the estimated undamped mode shape of the sample structure and the smooth polynomial of the undamaged structure using curvature damage indices (CDI) to determine the location of damage in the sample structure.

In some embodiments of the second aspect, a location of damage in the sample structure evidences that the sample structure is damaged. In some embodiments, the laser-based vibration measurement system is a continuously scanning laser vibrometer (CSLV) system. In some embodiments, the CSLV system is a continuously scanning laser Doppler vibrometer (CSLDV) system. In some embodiments, the laser-based vibration measurement system includes a scanner. In some embodiments, the laser-based vibration measurement system includes a scanner with a set of orthogonal mirrors. In some embodiments, the laser-based vibration measurement system scans at least a portion of a surface of the sample structure using a one-dimensional (1D) scan scheme. In some embodiments, the laser-based vibration measurement system scans at least a portion of a surface of the sample structure using a two-dimensional (2D) scan scheme. In some embodiments, the reference sensor system comprises a single-point laser vibrometer, e.g., a single-point laser Doppler vibrometer. In some embodiments, the cross-correlation function is transformed to a frequency spectrum using a signal processing method such as FFT, and an estimated damped natural frequency of the sample structure is obtained. In some embodiments, two or more CDIs are averaged and normalized to mitigate noise effects to further improve damage location identification. In some embodiments, CDIs in normalized ranges [0, 0.1] and [0.9, 1] of the full length of the sample structure were disregarded to eliminate effects of spurious boundary anomalies. In some embodiments, the sample structure is a beam structure. In some other embodiments, the sample structure is a plate structure.

In some embodiments, the methods of the first or second aspect described herein is not used in situations where the structure experiences sinusoidal excitation. In some embodiments, the method described herein does not use a band-pass filter to process any of the measurements. Further, the methods of the first or second aspect described herein do not utilize or apply on any image-based systems or methods, any tracking systems or methods, and no lifting method is required.

In some embodiments, when damage of the sample structure is detected using any method described herein, the skilled artisan or user can do refinement at the damage to avoid potential failure of the structure, or replace the damaged structure with an undamaged one.

### Computer Program Products

The present subject matter described herein may be a method and/or a computer program product. In some embodiments, the computer program product may include a computer readable storage medium (or media) having computer readable program instructions thereon for causing a processor to carry out aspects of the present subject matter.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In a third aspect, a computer program product comprising a computer readable storage medium having program instructions embodied therewith is described, the program instructions executable by a computing device to cause the computing device to estimate damped natural frequencies of a sample structure under random excitation by:
calculating a cross-correlation function between measurements of the sample structure obtained using a laser-based vibration system and measurements of at least one reference point of the sample structure obtained using a reference sensor system; and
transforming the cross-correlation function to a frequency spectrum to obtain the estimated damped natural frequency of the sample structure.

In some embodiments of the third aspect, the laser-based vibration measurement system is a continuously scanning laser vibrometer (CSLV) system. In some embodiments, the CSLV system is a continuously scanning laser Doppler vibrometer (CSLDV) system. In some embodiments, the laser-based vibration measurement system includes a scanner. In some embodiments, the laser-based vibration measurement system includes a scanner with a set of orthogonal mirrors. In some embodiments, the laser-based vibration measurement system scans at least a portion of a surface of the sample structure using a one-dimensional (1D) scan scheme. In some embodiments, the laser-based vibration measurement system scans at least a portion of a surface of the sample structure using a two-dimensional (2D) scan scheme. In some embodiments, the reference sensor system comprises a single-point laser vibrometer, e.g., a single-point laser Doppler vibrometer. In some embodiments, the cross-correlation function is transformed to a frequency spectrum using a signal processing method such as FFT, and an estimated damped natural frequency of the sample structure is obtained. From the estimated damped natural frequency of the sample structure, two sinusoidal signals can be created, for example, sin (@id t) and cos (@id t). Thereafter, an estimated undamped mode shape can be obtained by multiplying the two sinusoidal signals by the cross-correlation function and filtering the result using a low-pass filter. In some embodiments, the estimated undamped mode shape of the sample structure is used to detect damage to the sample structure. First, a hypothetical undamaged structure is simulated using a fitted smooth polynomial to the estimated undamped mode shape of the sample structure, which permits the baseline-free damage detection described herein. Second, the estimated undamped mode shape of the sample structure and the smooth polynomial representing the hypothetical undamaged structure are compared using CDI to determine the location of damage in the sample structure. In some embodiments, locating the damage in the sample structure is evidence that the sample structure is damaged. In some embodiments, two or more CDIs are averaged and normalized to mitigate noise effects to further improve damage location identification. In some embodiments, CDIs in normalized ranges [0, 0.1] and [0.9, 1] of the full length of the sample structure were disregarded to eliminate effects of spurious boundary anomalies. In some embodiments, the sample structure is a beam structure. In some other embodiments, the sample structure is a plate structure.

In a fourth aspect, a computer program product comprising a computer readable storage medium having program instructions embodied therewith is described, the program instructions executable by a computing device to cause the computing device to detect damage to a sample structure by:
calculating a cross-correlation function between measurements of the sample structure obtained using a laser-based vibration system and measurements of at least one reference point of the sample structure obtained using a reference sensor system;
transforming the cross-correlation function to a frequency spectrum to obtain an estimated damped natural frequency of the sample structure under random excitation;
creating two sinusoidal signals from the estimated damped natural frequency of the sample structure;
obtaining an estimated undamped mode shape of the sample structure by multiplying the calculated cross correlation function by the two sinusoidal signals and filtering the result using a low-pass filter;
simulating a hypothetical undamaged structure using a fitted smooth polynomial to the estimated undamped mode shape of the sample structure; and
comparing the estimated undamped mode shape of the sample structure and the smooth polynomial of the undamaged structure using curvature damage indices (CDI) to determine the location of damage in the sample structure.

In some embodiments of the fourth aspect, a location of damage in the sample structure evidences that the sample structure is damaged. In some embodiments, the laser-based vibration measurement system is a continuously scanning laser vibrometer (CSLV) system. In some embodiments, the CSLV system is a continuously scanning laser Doppler vibrometer (CSLDV) system. In some embodiments, the laser-based vibration measurement system includes a scanner. In some embodiments, the laser-based vibration measurement system includes a scanner with a set of orthogonal mirrors. In some embodiments, the laser-based vibration measurement system scans at least a portion of a surface of the sample structure using a one-dimensional (1D) scan scheme. In some embodiments, the laser-based vibration measurement system scans at least a portion of a surface of the sample structure using a two-dimensional (2D) scan scheme. In some embodiments, the reference sensor system comprises a single-point laser vibrometer, e.g., a single-point laser Doppler vibrometer. In some embodiments, the cross-correlation function is transformed to a frequency spectrum using a signal processing method such as FFT, and an estimated damped natural frequency of the sample structure is obtained. In some embodiments, two or more CDIs are averaged and normalized to mitigate noise effects to further improve damage location identification. In some embodiments, CDIs in normalized ranges [0, 0.1] and [0.9, 1] of the full length of the sample structure were disregarded to eliminate effects of spurious boundary anomalies. In some embodiments, the sample structure is a beam structure. In some other embodiments, the sample structure is a plate structure.

### EXAMPLE

### I. Methodology

a. Correlation Function Between A CSLDV Measurement and A Measured Reference Signal

When white-noise excitation is applied at point q of a linear time-invariant structure, its response can be expressed by

$$u ( t ) = {\sum }_{i = 1}^{N} {ϕ}_{i} {\int }_{- ∞}^{t} {ϕ}_{i , q} {f}_{q} ( t ) {g}_{i} ( t - τ ) d τ \qquad ( 1 )$$

where ϕ_{i,q} and f_{q} denote the entry of the i-th undamped mode shape of the structure ϕᵢ corresponding to q and white-noise excitation at q, respectively, and

$${g}_{i} ( t ) = \frac{1}{{ω}_{i , d}} {e}^{- {ζ}_{i} {ω}_{i} t} sin ( {ω}_{i , d} t )$$

where ω_{i,d} is the i-th damped natural frequency, ζᵢ is the i-th modal damping ratio, and ωᵢ is the i-th undamped natural frequency. The response of the structure at point p can be expressed by

$${u}_{p} ( t ) = {\sum }_{i = 1}^{N} {ϕ}_{i , p} {\int }_{- ∞}^{t} {ϕ}_{i , q} {f}_{q} ( t ) {g}_{i} ( t - τ ) d τ \qquad ( 2 )$$

where ϕ_{i,p} denotes the entry of ϕᵢ corresponding to p. When a CSLDV system measures the response of the structure along an arbitrary scan path s assigned on a surface of the structure, the laser spot of the system sweeps along s, and the measured response can be expressed by

$${u}_{s} ( t ) = {\sum }_{i = 1}^{N} {\tilde{ϕ}}_{i , s ( t )} {\int }_{- ∞}^{t} {ϕ}_{i , q} {f}_{q} ( t ) {g}_{i} ( t - τ ) d τ \qquad ( 3 )$$

where \tilde{ϕ}_{i,s} is a function of t and denotes the entry of ϕᵢ corresponding to a point on the structure, at which the laser spot arrives at time t.

A cross-correlation function between uₚ(t) and uₛ(t) can be calculated as the expected value of their product. The cross-correlation function with uₚ(t) and uₛ(t) serving as reference and measurement data, respectively, can be expressed by

$${R}_{psq} [ {u}_{p} ( {t}_{1} ) , {u}_{s} ( {t}_{2} ) ] = E [ {u}_{p} ( {t}_{1} ) {u}_{s} ( {t}_{2} ) ] \qquad ( 4 )$$

where E[·] is the expectation operator, and t₁ and t₂ are two time variables corresponding to uₚ(t) and uₛ(t), respectively. Let T be a time-delay variable; one has t₂=t₁+T, and Eq. (4) becomes

$${R}_{p s q} ( {t}_{1} , T ) = E [ {u}_{p} ( {t}_{1} ) {u}_{s} ( {t}_{1} + T ) ] \qquad ( 5 )$$

Substituting Eqs. (2) and (3) into Eq. (5) yields

$${R}_{p s q} ( {t}_{1} , T ) = E [ {\sum }_{i = 1}^{N} {\sum }_{j = 1}^{N} {ϕ}_{i , q} {ϕ}_{i , p} {ϕ}_{j , q} {\tilde{Φ}}_{j , s ( {t}_{1} + T )} {\int }_{- ∞}^{{t}_{1}} {\int }_{- ∞}^{{t}_{1} + T} {g}_{i} ( {t}_{1} - σ ) {g}_{j} ( {t}_{1} + T - τ ) {f}_{q} ( σ ) {f}_{q} ( τ ) d σ d τ ] \qquad ( 6 )$$

Since only f is random in Eq. (6), it can be rewritten as

$${R}_{p s q} ( {t}_{1} , T ) = {\sum }_{i = 1}^{N} {\sum }_{j = 1}^{N} {ϕ}_{i , q} {ϕ}_{i , p} {ϕ}_{j , q} {\tilde{Φ}}_{j , s ( {t}_{1} + T )} {\int }_{- ∞}^{{t}_{1}} {\int }_{- ∞}^{{t}_{1} + T} {g}_{i} ( {t}_{1} - σ ) {g}_{j} ( {t}_{1} + T - τ ) E [ {f}_{q} ( σ ) {f}_{q} ( τ ) ] d σ d τ \qquad ( 7 )$$

The expected value of f_{q}(σ) f_{q}(τ) can be expressed by

$$E [ {f}_{q} ( σ ) {f}_{q} ( τ ) ] = {α}_{q} δ ( τ - σ ) \qquad ( 8 )$$

where α_{q} is a constant associated with f_{q} and δ is the Dirac delta function. Substituting Eq. (8) into Eq. (7) yields

$${R}_{p s q} ( {t}_{1} , T ) = {\sum }_{i = 1}^{N} {\sum }_{j = 1}^{N} {α}_{q} {ϕ}_{i , q} {ϕ}_{i , p} {ϕ}_{j , q} {\tilde{Φ}}_{j , s ( {t}_{1} + T )} {\int }_{- ∞}^{{t}_{1}} {g}_{i} ( {t}_{1} - σ ) {g}_{j} ( {t}_{1} + T - σ ) d σ \qquad ( 9 )$$

Let λ=t₁-σ; one has

$${R}_{p s q} ( {t}_{1} , T ) = {\sum }_{i = 1}^{N} {\sum }_{j = 1}^{N} {α}_{q} {ϕ}_{i , q} {ϕ}_{i , p} {ϕ}_{j , q} {\tilde{Φ}}_{j , s ( {t}_{1} + T )} {\int }_{0}^{+ ∞} {g}_{i} ( λ ) {g}_{j} ( T + λ ) d λ \qquad ( 10 )$$

### Substituting

$${g}_{i} ( t ) = \frac{1}{{ω}_{i , d}} {e}^{- {ζ}_{i} {ω}_{i} t} sin ( {ω}_{i , d} t )$$

into Eq. (10) yields

$${R}_{p s q} ( {t}_{1} , T ) = {\sum }_{j = 1}^{N} {A}_{j} {\tilde{Φ}}_{j , s ( {t}_{1} + T )} {e}^{- {ζ}_{i} {ω}_{i} T} cos ( {ω}_{j , d} T - θ j ) \qquad ( 11 )$$

where Aⱼ is an amplitude constant, and θⱼ is a phase constant.

The cross-correlation function R_{psq} in Eq. (11) is different from that between responses of two fixed points, e.g., p and r, of the structure in that the former has two independent time variables, i.e., t₁ and T, and the latter has only one time-delay variable, i.e., T. The reason is that both uₚ and uᵣ are wide-sense stationary, as both E[uₚ] and E[u_{q}] are constants and independent of t. However, uₛ(t) is not wide-sense stationary, as E[u_{q}] is not a constant and depends on t due to continuous scanning of the CSLDV system.

This completes the theoretical derivation of a cross-correlation function between the response measured by a CSLDV system and that of a fixed point of a linear, time-invariant structure under white-noise excitation applied at a fixed point. Since the structure is linear, the superposition principle can be applied. The response of the structure under white-noise excitation applied at multiple points on it can be expressed as a sum of multiple responses under white-noise excitation applied at all the points. The resulting summed cross-correlation function has the same expression as that in Eq. (11), with the same mode shape \tilde{ϕ} and different Aⱼ and θⱼ.

### B. Demodulation Method for the Correlation Function

The correlation function R_{psq} can be written as

$${R}_{p s q} ( {t}_{1} , T ) = {\sum }_{j = 1}^{N} {C}_{j} ( T ) {\tilde{Φ}}_{j , s ( {t}_{1} + T )}^{i} cos ( {ω}_{j , d} T ) + {D}_{j} ( T ) {\tilde{Φ}}_{j , s ( {t}_{1} + T )}^{q} sin ( {ω}_{j , d} T ) \qquad ( 12 )$$

where Cⱼ(T) and Dⱼ(T) are two coefficients, and \tilde{ϕ}_{j,s(t}_{₁}_{+T)}ⁱ and \tilde{ϕ}_{j,s(t}_{₁}_{+T)}^{q} are in-phase and quadrature components of ϕ_{j,s(t}_{₁}_{+T)}, respectively. The correlation function is multiplied by a sinusoidal signal cos (ω_{k,d}T) where ω_{k,d} is the k-th damped natural frequency of the structure:

$${\sum }_{j = 1}^{N} {C}_{j} ( T ) {\tilde{Φ}}_{j , s ( {t}_{1} + T )}^{i} cos ( {ω}_{j , d} T ) cos ( {ω}_{k , d} T ) + {D}_{j} ( T ) {\tilde{Φ}}_{j , s ( {t}_{1} + T )}^{q} sin ( {ω}_{j , d} T ) cos ( {ω}_{k , d} T ) = {C}_{k} ( T ) {\tilde{Φ}}_{j , s ( {t}_{1} + T )}^{i} {cos}^{2} ( {ω}_{k , d} T ) + {D}_{k} ( T ) {\tilde{Φ}}_{j , s ( {t}_{1} + T )}^{q} sin ( {ω}_{k , d} T ) cos ( {ω}_{k , d} T ) + {\sum }_{j = 1}^{k - 1} {C}_{j} ( T ) {\tilde{Φ}}_{j , s ( {t}_{1} + T )}^{i} cos ( {ω}_{j , d} T ) cos ( {ω}_{k , d} T ) + {D}_{j} ( T ) {\tilde{Φ}}_{j , s ( {t}_{1} + T )}^{q} sin ( {ω}_{j , d} T ) cos ( {ω}_{k , d} T ) + {\sum }_{j = k + 1}^{N} {C}_{j} ( T ) {\tilde{Φ}}_{j , s ( {t}_{1} + T )}^{i} cos ( {ω}_{j , d} T ) cos ( {ω}_{k , d} T ) + {D}_{j} ( T ) {\tilde{Φ}}_{j , s ( {t}_{1} + T )}^{q} sin ( {ω}_{j , d} T ) cos ( {ω}_{k , d} T ) \qquad ( 13 )$$

The k-th damped natural frequency of the structure can be determined by applying the fast Fourier transform to R_{psq}. By using the double-angle formula, one has

$${C}_{k} ( T ) {\tilde{Φ}}_{j , s ( {t}_{1} + T )}^{i} {cos}^{2} ( {ω}_{k , d} T ) = \frac{1}{2} {C}_{k} ( T ) {\tilde{Φ}}_{j , s ( {t}_{1} + T )}^{i} + \frac{1}{2} {C}_{k} ( T ) {\tilde{Φ}}_{j , s ( {t}_{1} + T )}^{i} cos ( 2 {ω}_{k , d} T ) \qquad ( 14 )$$

By applying a low-pass filter to Eq. (13), the term ϕ_{j,s(t}_{₁}_{+T)}ⁱ can be extracted based on Eq. (14). Similarly, one can multiply Eq. (12) by a sinusoidal signal sin(ω_{k,d}T) to extract ϕ_{j,s(t}_{₁}_{+T)}^{q}. Once \tilde{ϕ}_{j,s(t}_{₁}_{+T)}ⁱ and \tilde{ϕ}_{j,s(t}_{₁}_{+T)}^{q} are obtained, one can estimate \tilde{ϕ}_{j,s(t}_{₁}_{+T)}, which is the undamped mode shape of the structure on the scan path s.
c. Baseline-Free Damage Detection Method

The curvature of \tilde{ϕ}_{j,s(t}_{₁}_{+T)} can be calculated by

$${\tilde{Φ}}_{j , s ( {t}_{1} + T )}^{″} = \frac{{d}^{2} {\tilde{Φ}}_{j , s ( {t}_{1} + T )}}{{dx}^{2}} \qquad ( 15 )$$

where x denotes a spatial position along the scan path s. The polynomial fit of \tilde{ϕ}_{j,s(t}_{₁}_{+T)} can be calculated as a baseline:

$${\tilde{Φ}}_{j , s ( {t}_{1} + T )}^{p} = {\sum }_{h = 0}^{r} {β}_{h} {x}^{h} \qquad ( 16 )$$

where h is a natural number, βₕ is a constant coefficient corresponding to x^{h}, and r is the degree of the polynomial fit. The methods for determining a proper r and calculating βₕ have been discussed in Ref. [Xu, et al., 2019]. Differences between curvatures of \tilde{ϕ}_{j,s(t}_{₁}_{+T)} and the polynomial fit can be obtained by

$$δ = {[ {\tilde{Φ}}_{j , s ( {t}_{1} + T )}^{″} - ( {\sum }_{h = 0}^{r} {β}_{h} {h}^{2} {x}^{h - 2} ) ]}^{2} \qquad ( 17 )$$

where δ is a CDI. Locations of damages in the structure can be identified in neighborhoods with high values in CDIs that correspond to different \tilde{ϕ}_{j,s(t}_{₁}_{+T)}. Note that signal-to-noise ratios of the measured response of a structure under random excitation can be low, and the neighborhoods with high values in estimated CDIs can be caused by noise. To remove noise in estimated CDIs and increase the accuracy of damage location identification, multiple estimated CDIs can be averaged by

$${δ}_{a} = \frac{1}{m} {\sum }_{l = 1}^{m} \frac{{δ}_{l}}{{δ}_{l , max}} \qquad ( 18 )$$

where l=1, 2, . . . , m, with m being the number of estimated CDIs, δₐ is an averaged and normalized CDI, δₗ is the l-th estimated CDI, and δ_{l,max} is the maximum value of δₗ.

### II. Finite Element Simulation

a. Finite Element Model

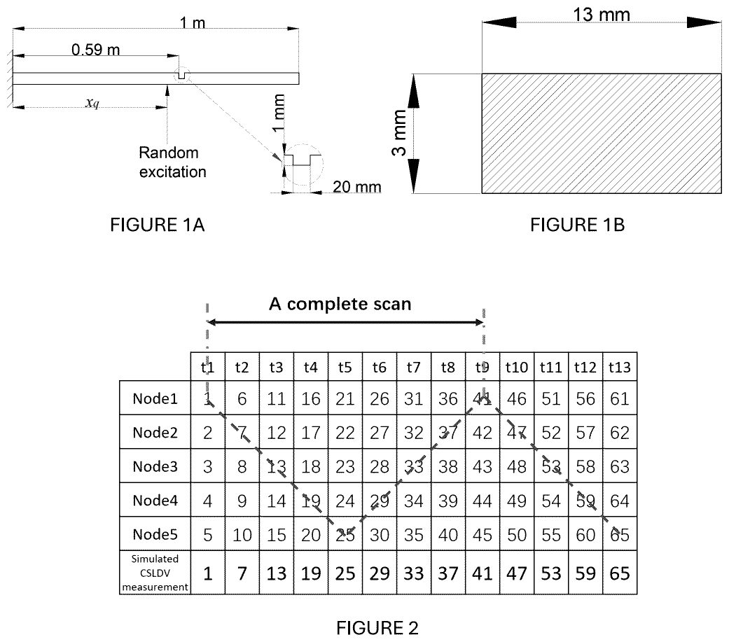

To validate the demodulation method with a reference signal, a finite element model of a damaged cantilever beam was developed in ABAQUS. The model was an Aluminum Euler-Bernoulli cantilever beam with a rectangular section of 13 mm×3 mm and a length of 1 m (see, FIGS. 1A-1B). The Young's modulus of the beam was set to be 70×109 Pa, the density of the beam was set to 2700 kg/m³, and the Poisson's ratio of the beam was set to 0.35. There was a thickness reduction region with a depth of 1 mm and a length of 20 mm along the length of the beam (FIG. 1A). The distance between the clamped end of the beam and the left end of the thickness reduction region was 0.59 m (FIG. 1A).

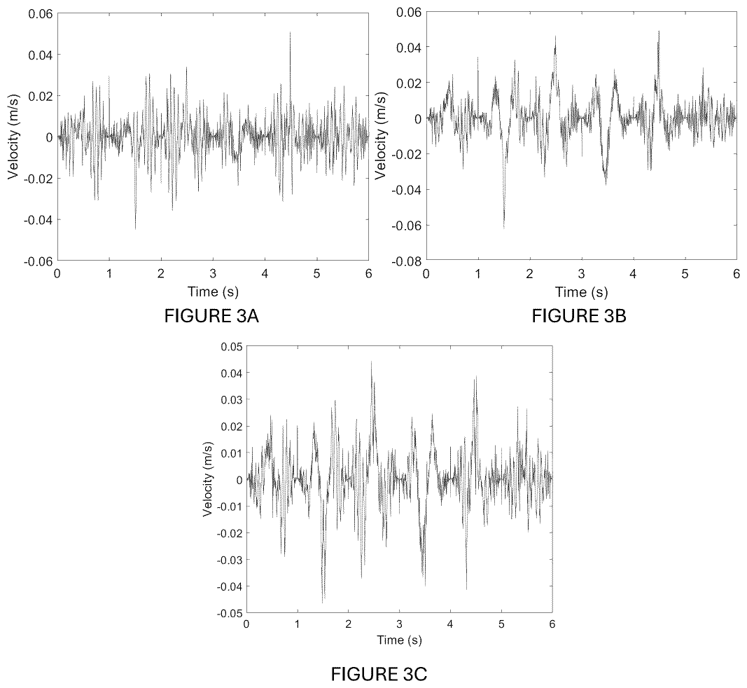

Beam elements were used for modeling the beam, and 500 elements with the same size were assigned to the finite element model. A concentrated random force excitation with a maximum value of 0.2 N and a standard deviation of 0.0558 was applied to a node of an element of the finite element model. The distance between the node and the fixed end of the finite element model is x_{q}. Nodes of the finite element model are considered as measurement points of a CSLDV system. The distance between a measurement point on the scan line and its start point was x and the total length of the scan line was L. A non-dimensional parameter η=x/L, whose scale was from 0 to 1, was be used to describe the location of a measurement point on the scan line. Simulated velocity responses of the beam were preprocessed to simulate measured responses of the CSLDV system when scanning back and forth along a straight line. A sample of preprocessing simulated responses is shown in FIG. 2. Simulated responses of 5 nodes at 13 instants form a matrix, where t1, t2, . . . , t13 denote 13 instants and integer numbers from 1 to 65 denote simulated responses. Responses 1, 7, 13, 19, and 25 are chosen as measured responses when the laser spot of the CSLDV system sweep from node 1 to node 5 at instants t1, t2, t3, t4, and t5 (see the dashed line in FIG. 2). Similarly, responses 25, 29, 33, 37, and 41 are chosen as measured responses when the laser spot sweeps from node 5 to node 1 at instants t5, t6, t7, t8, and t9. The above preprocess scheme can be applied to any simulated responses with certain nodes and instants to simulate measured responses of a CSLDV system. The response of a node can be used as a reference signal to calculate a correlation function. Note that for estimating a mode shape of the beam, one needs to apply a random excitation on a node that is not at a nodal point of the mode shape, and choose the response of a node that is not at a nodal point of the mode shape as a reference signal.

### B. Finite Element Simulation Results

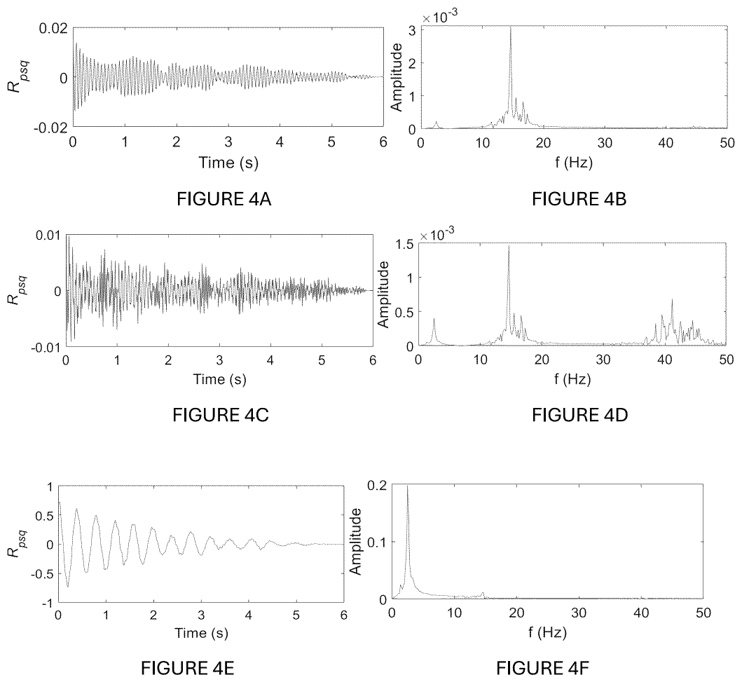

Simulated CSLDV measurements of the finite element model had a sampling frequency of 1000 Hz. Different excitation positions were used for estimating the first three bending modes of the beam, and simulated CSLDV measurements are shown in FIGS. 3A-3C. Based on the preprocess scheme in FIG. 2 and the sampling frequency being fₛₐ=1,000 Hz, the scan frequency, which is the number of completed scans in one second, is f_{sc}=1 Hz. Note that Nyquist frequency of a CSLDV measurement is the half of the sampling frequency of the laser in the CSLDV system, but the number of measurement points n in a complete scan depends on both the sampling frequency and the scan frequency: η=fₛₐ/f_{sc}, which means that increasing fₛₐ and decreasing f_{sc} can both increase n. Once n is increased, the spatial resolution of an undamped mode shape that is estimated from the CSLDV measurement is increased, and one can obtain more accurate OMA results and damage detection results.

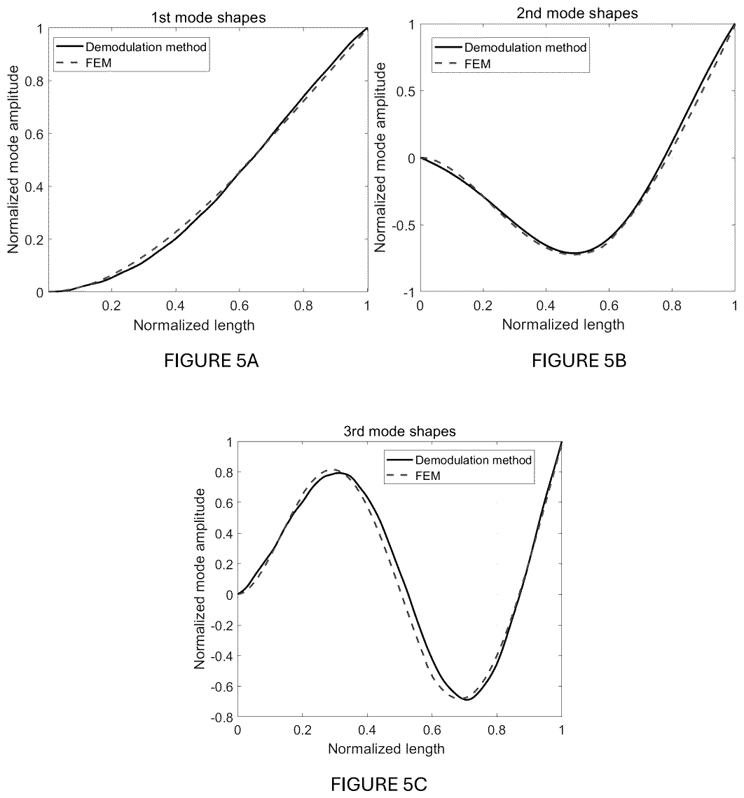

Responses at nodes of the finite element model were used as reference signals for calculating correlation functions. The method for calculation of correlation functions that is used in this example is an accurate and efficient calculation of discrete correlation functions that was developed in [Xu, et al., 2015]. Proper nodes are needed for estimating an undamped mode shape. Responses at nodes where the undamped mode shape has a large amplitude while other undamped mode shapes have smaller amplitudes are suitable for estimating the undamped mode shape. Correlation functions between simulated CSLDV measurements in FIGS. 3A-3C and responses at nodes, and their frequency spectra are shown in FIGS. 4A-4C. The correlation function in FIG. 4A can be used for estimating the second undamped mode shape since it has a large amplitude at the node with x_{q}=0.5 m. Similarly, the correlation function in FIG. 4C can be used for estimating the third undamped mode shape, and the correlation function in FIG. 4E can be used for estimating the first undamped mode shape.

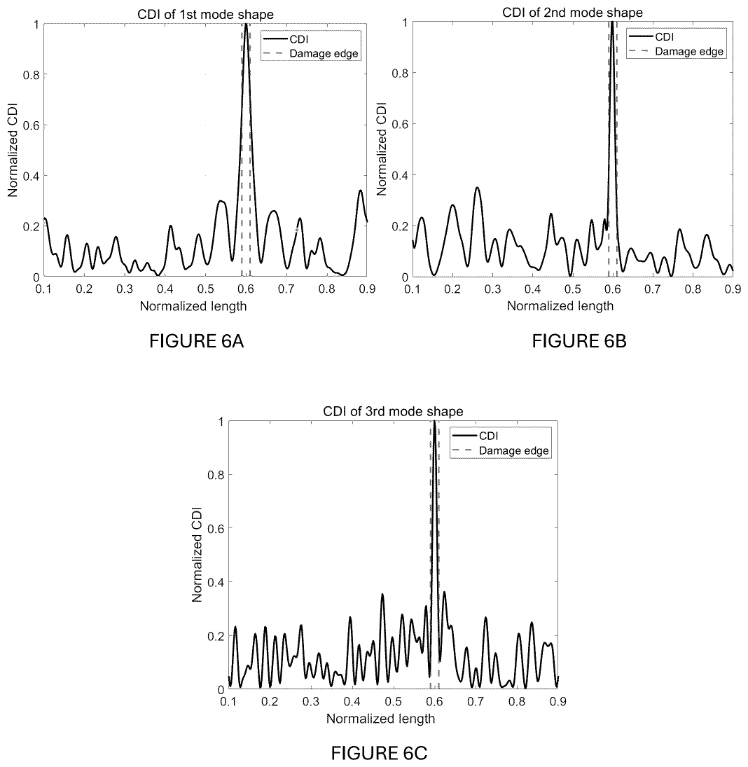

The calculated correlation function is processed using fast Fourier transforms to determine damped natural frequencies of the beam (Table 1), and obtained correlation functions were processed by the demodulation method to estimate undamped mode shapes of the beam. To validate estimated damped natural frequencies and undamped mode shapes, modal analysis of the finite element model in ABAQUS was used to estimate damped natural frequencies and undamped mode shapes of the beam. Estimated first three undamped mode shapes of the beam using the demodulation method and FEM are compared in FIGS. 5A-5C.

TABLE 1
Estimated damped natural frequencies of the beam

| | First damped | Second damped | Third damped |
|---|---|---|---|
| | natural frequency | natural frequency | natural frequency |
| | (Hz) | (Hz) | (Hz) |
| FFT | 2.50 | 14.67 | 42.50 |
| FEM | 2.46 | 14.89 | 42.56 |
| Difference | 1.63% | 1.48% | 0.14% |

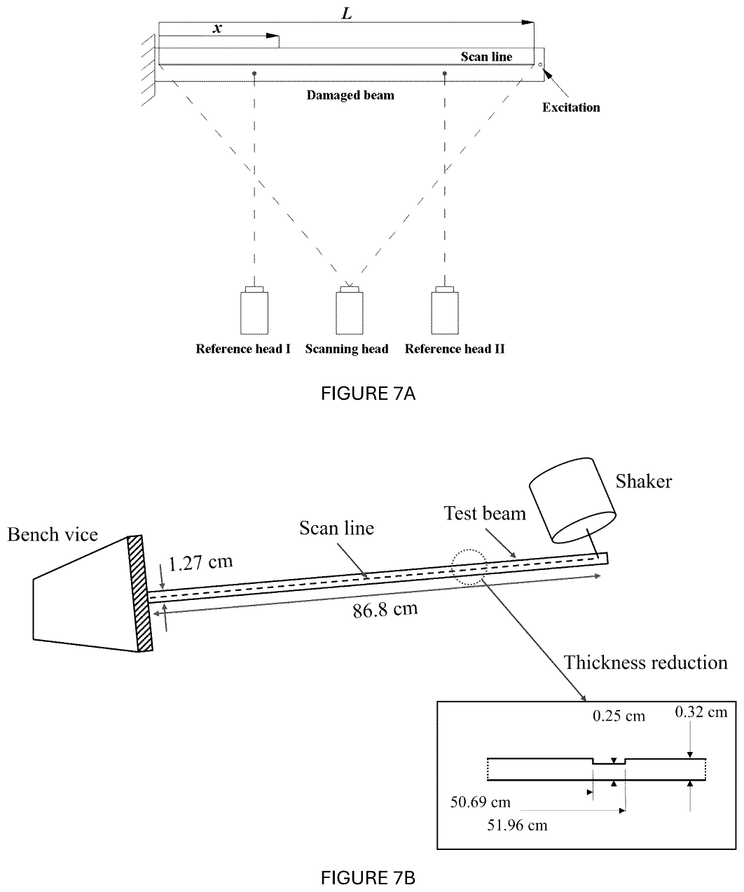

Modal assurance criterion (MAC) values between estimated first, second, and third undamped mode shapes of the beam using the demodulation method with a reference signal and FEM are 99.92%, 99.57%, and 98.79%, respectively. The demodulation method with a reference signal can accurately estimate modal parameters of the beam based on differences in Table 1 and MAC values. The base-line free damage detection method was applied to estimated undamped mode shapes using the demodulation method with a reference signal, and averaged and normalized CDIs are shown in FIGS. 6A-6C. CDIs in normalized ranges [0, 0.1] and [0.9, 1] were disregarded to eliminate effects of spurious boundary anomalies [Di Maio, et al., 2021]. The highest peak in CDI plots in FIGS. 6A-6C are at the location of the damage in the beam; the location the damage in the beam was accurately estimated using the demodulation method with a reference signal and base-line free damage detection method.

### III. Experimental Investigation

### a. Experimental Setup

A CSLDV system extended from a Polytec PSV-500-3D SLDV system was used to conduct experimental investigation on OMA and damage detection methods disclosed herein. An aluminum beam with a thickness reduction on its backside was used as the test structure in the experiment. The CSLDV system comprised an external controller and three laser heads, which were referred to as the scanning head and reference heads I and II based on their roles during the test, as shown in FIG. 7A. Mirrors of the scanning head were controlled by the external controller dSPACE MicroLabBox to continuously rotate, so that its laser spot can continuously scan along a pre-designed scan line on the surface of the damaged beam. Laser spots of reference heads were fixed on the surface of the damaged beam to capture vibrations of reference points.

The experimental setup of the CSLDV measurement of the damaged beam is shown in FIG. 7B. One end of the beam was clamped by a bench vice and the other end was connected to a stinger of a MB Dynamics modal-50 ashaker. A white-noise signal was input into the shaker to provide excitation. The thickness reduction damage on the backside of the beam was zoomed in and shown on the right bottom part of FIG. 7B. The reduced thickness is about 21.8% of the full thickness of the beam. One can see from FIG. 7B that L=86.8 cm, and the damaged area started at η=0.584 and ended at η=0.598, meaning that its length is about 1.4% of the full length of the scan line. The scanning frequency of CSLDV measurements was f_{sc}=1 Hz, and its sampling frequency was fₛₐ=1,000 Hz, which provided a total number of N=fₛₐ/2_{sc}=500 measurement points on the scan line. A modal test using the SLDV system was conducted in a step-wise way on the damaged beam with the same experimental setup as that shown in FIG. 7B to obtain its first three damped natural frequencies and mode shapes, which were compared with corresponding results from CSLDV measurements to validate the proposed OMA method. An algorithmic diagram of the demodulation method with a reference signal for OMA and damage detection is shown in FIG. 7C.

### B. Experimental Results of Modal Parameter Estimation and Damage Detection

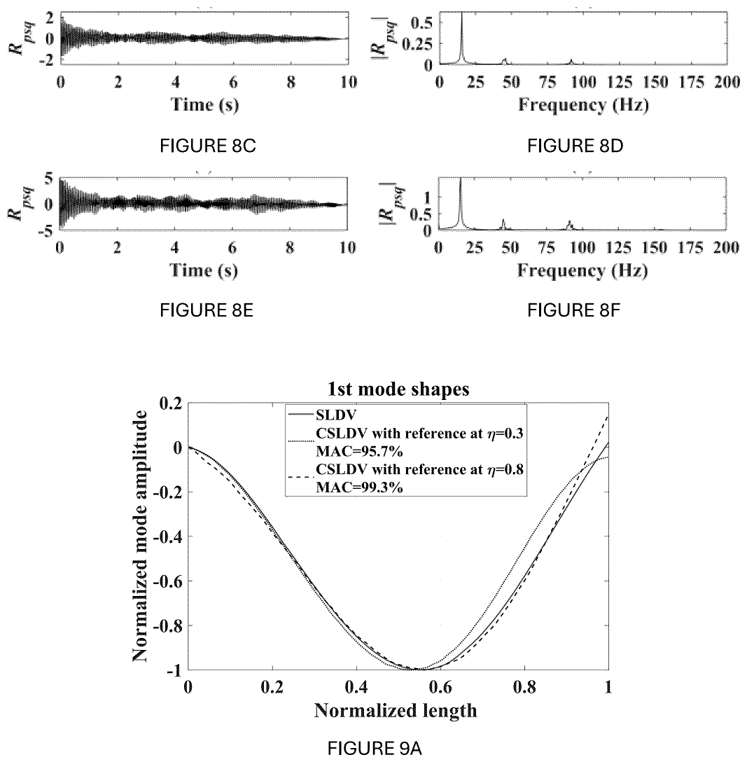

Vibrations of points at η=0.3 and η=0.8 were selected as two references in the experiment to avoid nodal points of the first three modes of the damaged beam, and correlation functions R_{psq} between them and vibrations from the scanning head were obtained. In one set of measurements, vibrations with a duration of 10 seconds were captured by reference and scanning heads. The first step of modal parameter estimation of the damaged beam is to identify its damped natural frequencies. The vibration of the damaged beam under white-noise excitation from CSLDV measurements is shown in FIG. 8A and its frequency spectrum is shown in FIG. 8B. One can see that it is difficult to directly identify damped natural frequencies of the beam from its frequency spectrum due to the low signal-to-noise ratio of the response of the beam under white-noise excitation. Correlation functions using references at η=0.3 and η=0.8 are shown in FIGS. 8C and 8E, respectively, and their frequency spectra are shown in FIGS. 8D and 8F, respectively. The first three damped natural frequencies of the damaged beam can be identified from frequency spectra of correlation functions in the two cases. As listed in Table 2, the maximum absolute error between the first three damped natural frequencies of the beam from SLDV measurements and those from CSLDV measurements with the reference at η=0.3 is 1.3%, and that for η=0.8 is 0.9%.

TABLE 2
Comparison between damped natural frequencies of the damaged beam from SLDV measurements
and those from CSLDV measurements with references at η = 0.3 and η = 0.8.

| Mode | SLDV | CSLDV measurement with reference | | | |
|---|---|---|---|---|---|
| No. | measurement | n = 0.3 | Error | n = 0.8 | Error |
| 1 | 15.6 Hz | 15.5 Hz | −0.6% | 15.7 Hz | 0.6% |
| 2 | 45.0 Hz | 45.2 Hz | 0.4% | 44.6 Hz | 0.9% |
| 3 | 91.3 Hz | 90.1 Hz | −1.3% | 91.7 Hz | 0.4% |

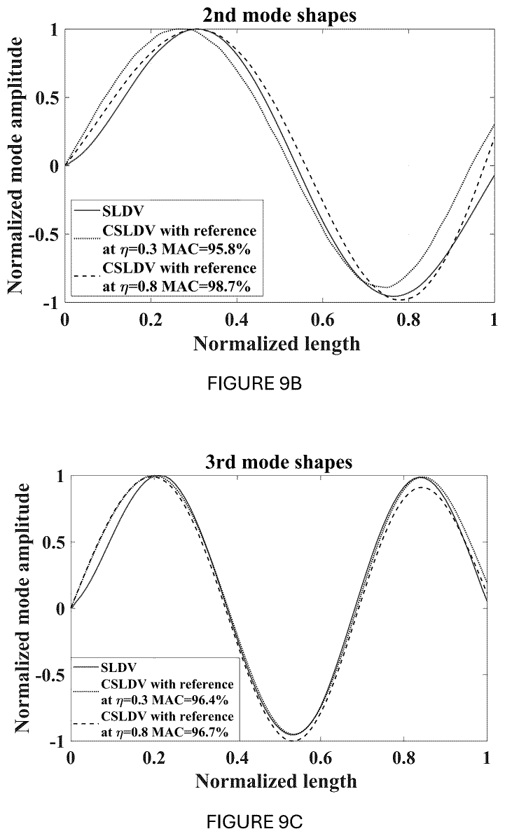

Based on Eq. (12) herein, undamped mode shapes of the damaged beam can be estimated from correlation functions shown in FIGS. 8A-8F using its identified natural frequencies and the demodulation method with a reference signal. In this work, the first three undamped mode shapes of the beam were estimated from CSLDV measurements with references at η=0.3 and η=0.8 and compared with those from SLDV measurements, as shown in FIGS. 9A-9C, where solid lines denote mode shapes from SLDV measurements, and black dotted lines and blue dashed lines denote mode shapes from CSLDV measurements with references at η=0.3 and η=0.8, respectively. One can see that MAC values between the first three mode shapes of the beam from SLDV and CSLDV measurements are larger than 95.7% when η=0.3, and larger than 96.7% when η=0.8.

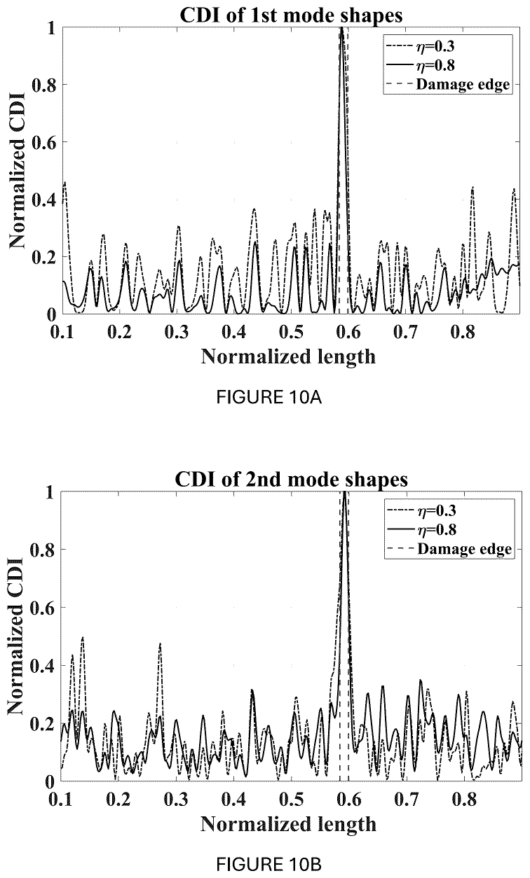

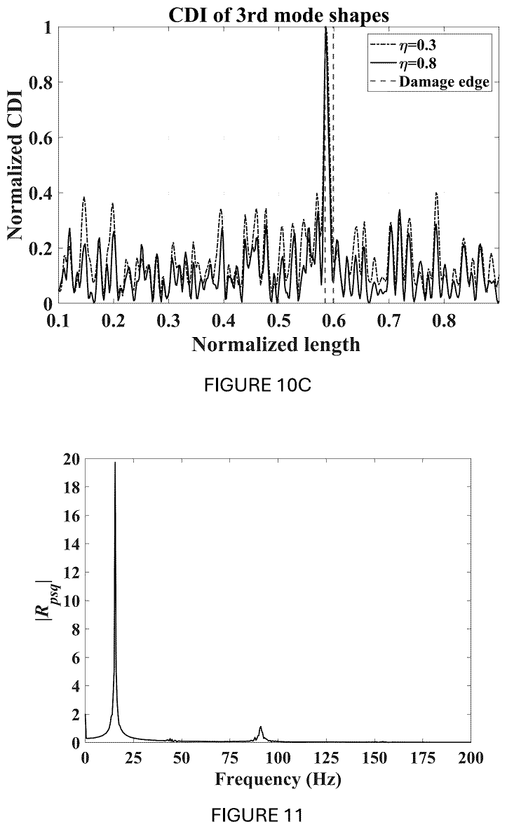

In order to reduce the noise of damage detection results, the set of vibration data with a duration of 10 s captured in CSLDV measurements with a reference signal was split in ten sets with durations of 1 s. Ten CDIs were calculated using Eq. (17) for each mode, and normalization and averaging were conducted on them to obtain final CDI results using Eq. (18) where m=10 in the experiment. As shown in FIGS. 10A-10C, the location of damage can be identified from peaks of CDI results from CSLDV measurements with references at η=0.3 and η=0.8. Note that the noise of CDI results for η=0.8 was slightly smaller than that for η=0.3.

Based on experimental results, the demodulation method with a reference signal and the baseline-free damage detection method can be used for high-accuracy damage location identification of a beam structure under random excitation, while the traditional demodulation method cannot. However, the demodulation method with a reference signal requires both a CSLDV system and a sensor for measuring responses of the structure. Moreover, to estimate multiple modes of a structure, reference signals measured from multiple positions on the structure are needed to increase signal-to-noise ratios of measured reference signals. If only one position is used for a reference signal, the position may be close to a nodal point of a measured mode shape of the structure so that the signal-to-noise ratio of the measured reference signal is too low for estimating the mode shape. The frequency spectrum in FIG. 4B can only be used for identifying the second damped natural frequency of the FEM since the amplitude of the second undamped mode shape is large at the reference node while amplitudes of the other two undamped mode shapes are small. The frequency spectrum of the correlation function between the response from the scanning head and the reference response at η=0.5 is shown in FIG. 10. One can see that the second natural frequency of the beam cannot be identified from the frequency spectrum, since η=0.5 is close to the nodal point of the second mode shape of the beam. The demodulation method with a reference signal is more complicated than the traditional demodulation method.

The lifting method can also be used for damage location identification of a beam structure under random excitation, but it has some more limitations than the demodulation method with a reference signal. The lifting method requires the laser spot of the CSLDV system to sweep along prescribed scan paths with a sufficiently high speed. The Nyquist frequency of the CSLDV system when using the lifting method is equal to its scanning frequency, which means that it is difficult to use the CSLDV system to estimate modal parameters of a structure with high natural frequencies. It is also difficult to use the lifting method for a 2D scan since scanning along a 2D path takes much more time than scanning along a 1D path, which greatly reduces the scanning frequency of the CSLDV system. Moreover, measured responses of the lifting method are reconstructed to measured responses at multiple measurement points as if there are sensors attached to these points. The spatial resolution of the lifting method depends on the number of measurement points. Measured responses at measurement points need to be separately processed, which can take much time for processing if the spatial resolution of the lifting method is high. The demodulation method with a reference signal can estimate modal parameters of a structure with high natural frequencies since the Nyquist frequency of the CSLDV system when using the demodulation method with a reference signal depends on the sampling frequency of the system.

### IV. CONCLUSION

A demodulation method with a reference signal has been developed for processing measured responses of a damaged structure under random excitation by a CSLDV system. Correlation functions between CSLDV measurements and measured responses at a reference point are calculated and multiplied by sinusoidal signals whose frequencies are damped natural frequencies of the structure. Multiplied correlation functions are filtered by low pass filters to obtain undamped mode shapes of the structure. A baseline-free damage detection method is used to calculate curvatures of estimated undamped mode shapes and compare obtained curvatures with curvatures of polynomial-fitted undamped mode shapes. CDIs are calculated, which can show the location of a damage in the structure. Both numerical and experimental investigations are conducted to validate the novel demodulation method with a reference signal and base-line damage detection method. Locations of damages in beams are accurately estimated in numerical and experimental investigations. A disadvantage of the damage detection method is that damages at the boundary of the structure cannot be detected by the damage detection method since CDIs in normalized ranges [0, 0.1] and [0.9, 1] were disregarded to eliminate effects of spurious boundary anomalies, and extents of damages are not provided in estimated CDIs. That said, the demodulation method with a reference signal can be used for structural health monitoring of a beam structure under random excitation by processing measurements from a CSLDV system with a low scan frequency and a reference sensor, while demodulation methods and lifting methods of the prior art cannot.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

### REFERENCES

Allen, M. S., and Sracic, M. W., A new method for processing impact excited continuous-scan laser Doppler vibrometer measurements, Mech. Syst. Signal Process. 24(3) (2010), pp. 721-735.
Castellini, P., Martarelli, M., and Tomasini, E., Laser Doppler vibrometry: development of advanced solutions answering to technology's needs. Mech. Syst. Signal Process. 20(6) (2006), pp. 1265-1285.
Chen, D. M., Xu, Y. F., and Zhu, W. D., Damage identification of beams using a continuously scanning laser Doppler vibrometer system, J. Vib. Acoust. 138(5) (2016), p. 05011.
Chen, D. M., Xu, Y. F., and Zhu, W. D., Experimental investigation of notch-type damage identification with a curvature-based method by using a continuously scanning laser Doppler vibrometer system, J. Nondestruct. Eval. 36(2) (2017), p. 38.
Chen, D. M., Xu, Y. F., and Zhu, W. D., Identification of damage in plates using full-field measurement with a continuously scanning laser Doppler vibrometer system, J. Sound Vib. 422 (2018), pp. 542-567.
Chen, D., Xu, Y. F., and Zhu, W. D., Non-model-based identification of delamination in laminated composite plates using a continuously scanning laser Doppler vibrometer system. J. Vib. Acoust. 140 (4) (2018), 041001.
Chen, D M., Xu, Y. F., and Zhu, W. D., A comprehensive study on detection of hidden delamination damage in a composite plate using curvatures of operating deflection shapes, J. Nondestruct. Eval. 38 (2019), p. 54.
Chen, D. M., and W. D. Zhu, Investigation of three-dimensional vibration measurement by three scanning laser Doppler vibrometers in a continuously and synchronously scanning mode. J. Sound Vib., 498 (2021), p. 115950.
Di Maio, D., and Ewins, D., Continuous scan, a method for performing modal testing using meaningful measurement parameters; Part I, Mech. Syst. Signal Process. 25(8) (2011), pp. 3027-3042.
D. Di Maio, P. Castellini, M. Martarelli, S. Rothberg, M. S. Allen, W. D. Zhu, and D. J. Ewins, Continuous Scanning Laser Vibrometry: A raison d′être and applications to vibration measurements. Mech. Syst. Signal Process. 156 (2021), p. 107573.
He, M., Yang, T., and Du, Y., Nondestructive identification of composite beams damage based on the curvature mode difference. Compos. Struct. 176 (2017), pp. 178-186.
Huang, Z., and Zang, C., Damage Detection Using Modal Rotational Mode Shapes Obtained with a Uniform Rate CSLDV Measurement, Appl. Sci. 9(23) (2019), p. 4982.
Lestari, W., Qiao, P., and Hanagud, S., Curvature mode shape-based damage assessment of carbon/epoxy composite beams. J. Intell. Mater. Syst. Struct. 18(3) (2007), pp. 189-208.
Lyu, L. F., and Zhu, W. D., Operational modal analysis of a rotating structure subject to random excitation using a tracking continuously scanning laser Doppler vibrometer via an improved demodulation method, ASME. J. Vib. Acoust., 144(1) (2021), p. 011006.
Lyu, L. F., and Zhu, W. D., Operational modal analysis of a rotating structure under ambient excitation using a tracking continuously scanning laser Doppler vibrometer system, Mech. Syst. Signal Process., 152 (2021), p. 107367.
Lyu, L. F., and Zhu, W. D., Full-field mode shape estimation of a rotating structure subject to random excitation using a tracking continuously scanning laser Doppler vibrometer via a two-dimensional scan scheme, Mech. Syst. Signal Process. 169 (2022), p. 108532.
Lyu, L. F., Higgins, G. D., and Zhu, W. D., Operational modal analysis of a rotating structure using image-based tracking continuously scanning laser Doppler vibrometry via a novel edge detection method, J. Sound Vib., 525 (2022), p. 116797.
Rothberg, S., Allen, M., and Castellini, P., An international review of laser Doppler vibrometry: making light work of vibration measurement, Opt. Lasers Eng. 99(1) (2017), pp. 11-22.
Sriram, P., Hanagud, S., Craig, J., and Komerath, N. M., Scanning laser Doppler technique for velocity profile sensing on a moving surface, Appl. Opt. 29(16) (1990), pp. 2409-2417.
Sriram, P., Hanagud, S., and Craig, J., Mode shape measurement using a scanning laser Doppler vibrometer, Int. J. Anal. Exp. Modal anal. 7(3) (1992), pp. 169-178.
Stanbridge, A., and Ewins, D., Modal testing using a scanning laser Doppler vibrometer, Mech. Syst. Signal Process. 13(2) (1999), pp. 255-270.
Stoffregen, B., and Felske, A., Scanning laser Doppler vibration analysis system. SAE Transactions, 94(2) (1985), pp. 934-940, 1985.
Valdes, S. D., and Soutis, C., Delamination detection in composite laminates from variations of their modal characteristics. J. Sound Vib., 228(1) (1999), pp. 1-9.
Vuye, C., Vanlanduit, S., Presezniak, F., Steenackers, G., Guillaume, P., Optical measurement of the dynamic strain field of a fan blade using a 3D scanning vibrometer. Opt. Lasers Eng. 49 (7) (2011), pp. 988-997.
Xu, Y. F., Liu, J. M., and Zhu, W. D. Accurate and efficient calculation of discrete correlation functions and power spectra. J. Sound Vib., 347 (2015), pp. 246-265.
Xu, Y. F., Chen, D. M., and Zhu, W. D., Damage identification of beam structures using free response shapes obtained by use of a continuously scanning laser Doppler vibrometer system, Mech. Syst. Signal Process. 92 (2017), pp. 226-247.
Xu, Y. F., Chen, D. M., and Zhu, W. D., Operational modal analysis using lifted continuously scanning laser Doppler vibrometer measurements and its application to baseline-free structural damage identification, J. Vib. Control. 25(7) (2019), pp. 1341-1364.
Xu, Y. F., Chen, D. M., and Zhu, W. D., Modal parameter estimation using free response measured by a continuously scanning laser Doppler vibrometer system with application to structural damage identification, J. Sound Vib. 485 (2020), p. 115536.
Yang, S., and Allen, M. S., Lifting approach to simplify output-only continuous-scan laser vibrometry, Mech. Syst. Signal Process. 45(2) (2014), pp. 267-282.
Yuan, K., and Zhu, W. D., Estimation of modal parameters of a beam under random excitation using a novel 3D continuously scanning laser Doppler vibrometer system and an extended demodulation method, Mech. Syst. Signal Process. 155 (2021), p. 107606.
Yuan, K., and Zhu, W., Modeling of welded joints in a pyramidal truss sandwich panel using beam and shell finite elements. J. Vib. Acoust. 143 (4) (2021), pp. 041002.
Yuan, K., and Zhu, W. D., A novel general-purpose three-dimensional continuously scanning laser Doppler vibrometer system for full-field vibration measurement of a structure with a curved surface, J. Sound Vib., 540 (2022), p. 117274.
Yuan, K., and Zhu, W. D., In-plane operating deflection shape measurement of an aluminum plate using a three-dimensional continuously scanning laser Doppler vibrometer system, Exp. Mech., 62 (2022), pp. 667-676.
Yuan, K., and Zhu, W. D., Identification of modal parameters of a model turbine blade with a curved surface under random excitation with a three-dimensional continuously scanning laser Doppler vibrometer system, Measurement, 2023, p. 112759.

What is claimed is:

1. A demodulation method of estimating damped natural frequencies of a sample structure under random excitation, said method comprising:
measuring the sample structure using a laser-based vibration measurement system;
measuring at least one reference point on the sample structure using a reference sensor system;
calculating a cross-correlation function between the measurements of the laser-based vibration measurement system and the measurements of the reference sensor system; and
transforming the cross-correlation function to a frequency spectrum to obtain the estimated damped natural frequency of the sample structure.

2. The method of claim 1, wherein the reference sensor system comprises a single-point laser vibrometer.

3. The method of claim 1, wherein the laser-based vibration measurement system is a continuously scanning laser vibrometer (CSLV) system.

4. The method of claim 1, wherein the laser-based vibration measurement system is a continuously scanning laser Doppler vibrometer (CSLDV) system.

5. The method of claim 1, wherein transforming the cross-correlation function to a frequency spectrum is performed using fast Fourier transforms.

6. The method of claim 1, further comprising creating two sinusoidal signals from the estimated damped natural frequency of the sample structure.

7. The method of claim 6, further comprising obtaining an estimated undamped mode shape of the sample structure by multiplying the calculated cross correlation function by the two sinusoidal signals and filtering the result using a low-pass filter.

8. The method of claim 7, further comprising determining a location of damage to the structure by:
simulating a hypothetical undamaged structure using a fitted smooth polynomial to the estimated undamped mode shape of the sample structure; and
comparing the estimated undamped mode shape of the sample structure and the smooth polynomial of the undamaged structure using curvature damage indices (CDI) to determine the location of damage in the sample structure.

9. The method of claim 8, wherein two or more CDIs are averaged and normalized to mitigate noise effects to further improve damage location identification.

10. The method of claim 8, wherein CDIs in normalized ranges [0, 0.1] and [0.9, 1] of the full length of the sample structure were disregarded to eliminate effects of spurious boundary anomalies.

11. The method of claim 1, wherein the laser-based vibration measurement system scans at least a portion of a surface of the sample structure using a one-dimensional (1D) scan scheme.

12. The method of claim 1, wherein the laser-based vibration measurement system scans at least a portion of a surface of the sample structure using a two-dimensional (2D) scan scheme.

13. The method of claim 1, wherein the method provides baseline-free damage detection of the sample structure.

14. The method of claim 1, wherein the sample structure is a beam structure.

15. The method of claim 1, wherein the sample structure is a plate structure.

16. The method of claim 1, wherein random excitation corresponds to exposure to a broad spectrum of frequencies simultaneously.

17. The method of claim 1, wherein a band-pass filter is not used to process any of the measurements.

18. The method of claim 1, wherein no image-based systems or methods, no tracking systems or methods, and no lifting methods are used.
